(19) United States
(12) Patent Application Publication
(10) Pub. No.: US 2012/0229052 A1
(43) Pub. Date: Sep. 13, 2012

(54) AUTOMATIC LIGHTING SYSTEM

(76) Inventors: CHING-NAN YANG, New Taipei City (TW); Tsung-Chih Kao, New Taipei City (TW); Chun-Hsin Yang, New Taipei City (TW)

(21) Appl. No.: 13/042,462

(22) Filed: Mar. 8, 2011

(51) Int. Cl. H05B 37/02

(52) U.S. Cl. 315/362

(57) ABSTRACT

The automatic lighting system contains a lighting device, a control module controlling the lighting device, and a light switch through which the control module is connected to an in-house wiring in a series connection. The control module contains a power unit connecting the in-house wiring, a switch detection unit connecting the in-house wiring and the power unit, a control unit connecting the power unit and the switch detection unit, an activation unit connecting the power unit and the control unit, and a control switch connecting the in-house wiring and the control unit. The automatic lighting system provides an ordinary lighting mode functioning like an ordinary lamp and an automatic lighting mode which is triggered by ambient brightness, object movement, and preset schedule. A conventional automatic lighting could be directly replaced by a light device of the present invention without altering any existing wiring and switch configuration.

### (a) TECHNICAL FIELD OF THE INVENTION

The present invention is generally related to lighting apparatus, and more particularly to an automatic lighting system allowing multiple modes of automatic activation and deactivation.

### (b) DESCRIPTION OF THE PRIOR ART

Lamps and lighting devices are necessities of daily life. They not only provide illumination but also offer indication of presence so as to deter crimes.

To save energy and to prolong life span, automatic lighting devices are therefore provided so that, during day time or when illumination is not required, the light devices are not turned on. However, to install the automatic lighting devices, re-wiring and re-configuration are required, which is quite inconvenient.

### SUMMARY OF THE INVENTION

A major objective of the present invention is to provide a novel automatic lighting system capable of obviating the shortcomings of prior arts. The automatic lighting system contains a lighting device, a control module controlling the lighting device, and a light switch through which the control module is connected to an in-house wiring in a series connection. The control module contains a power unit connecting the in-house wiring, a switch detection unit connecting the in-house wiring and the power unit, a control unit connecting the power unit and the switch detection unit, an activation unit connecting the power unit and the control unit, and a control switch connecting the in-house wiring and the control unit. When the light switch is switched on or off and the interval from the last state change is longer than a discharge time of the power unit and a preset time duration of the switch detection unit, the lighting device is turned or off as an ordinary lighting device. On the other hand, if the interval from the last state change is shorter than the discharge time of the power unit and the preset time duration of the switch detection unit, the control module enters an automatic lighting mode. During this mode, when the activation unit detects that the ambient light is dimmed, or there is object movement, or a preset time is up, the control unit is notified to engage the control switch so that the lighting device is turned on. With the present invention, the lighting device could be turned on and off by the brightness of ambient light, object movement, and preset schedules, thereby achieving significant energy saving and extended life span. Most of all, a conventional automatic lighting could be directly replaced by a light device of the present invention without altering any existing wiring and switch configuration.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a schematic diagram showing the major functional blocks of a lighting system according to the present invention.

FIG. 2 is a flow diagram showing an operation scenario of a lighting system according to a first embodiment of the present invention.

FIG. 3 is a flow diagram showing an operation scenario of a lighting system according to a second embodiment of the present invention.

FIG. 4 is a flow diagram showing an operation scenario of a lighting system according to a third embodiment of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

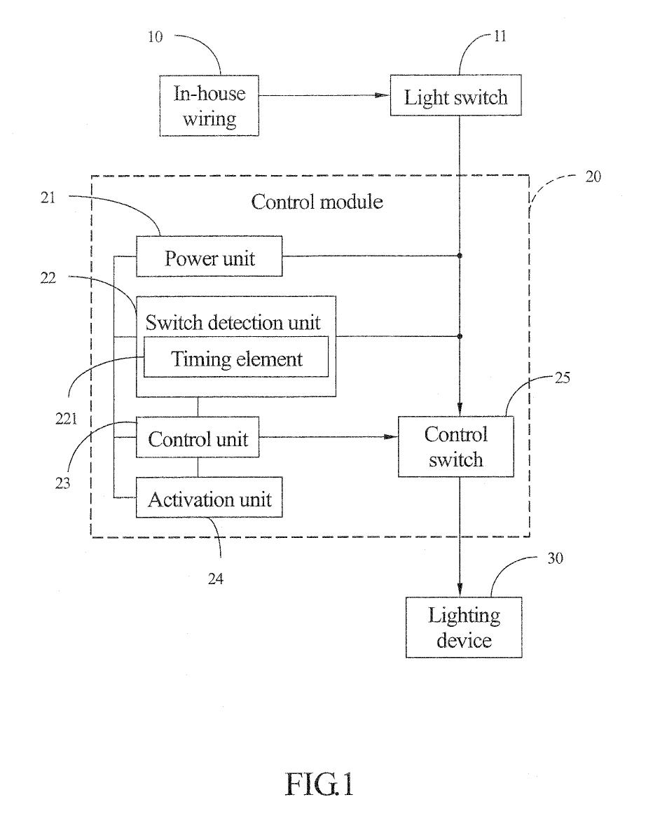

As shown in FIG. 1, a lighting system according to a first embodiment of the present invention contains a lighting device 30, a control module 20 controlling the lighting device 30, and a light switch 11 (such as a push button) through which the control module 20 is connected to an in-house wiring 10 in a series connection. The control module 20 contains a power unit 21 connecting the in-house wiring 10, a switch detection unit 22 connecting the in-house wiring 10 and the power unit 21, a control unit 23 connecting the power unit 21 and the switch detection unit 22, an activation unit 24 connecting the power unit 21 and the control unit 23, and a control switch 25 connecting the in-house wiring 10 and the control unit 23. The switch detection unit 22 contains a timing element 221 capable of determining an interval time from the last state change of the light switch 11. The activation unit 24 is one of a light-sensing activation unit, a motion-detection activation unit, and a time-based activation unit.

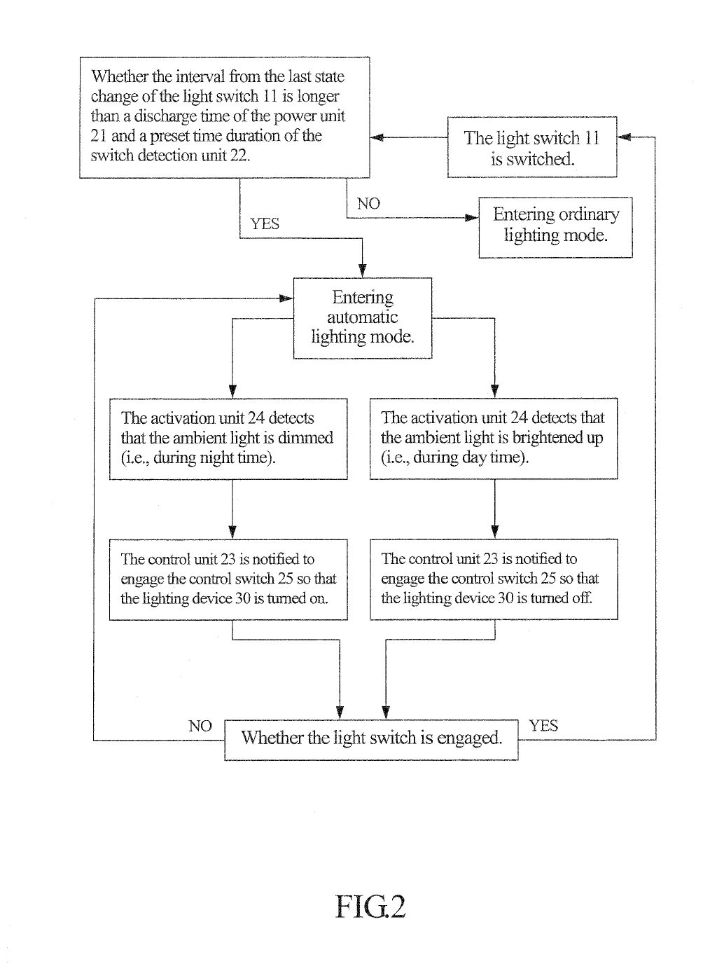

As illustrated and together with FIG. 2, an existing lighting device could be replaced by a new lighting device 30 configured with the control module 20, thereby delivering the functions specified by the present invention. When the light switch 11 is switched on or off and the interval from the last state change is longer than a discharge time of the power unit 21 and a preset time duration of the switch detection unit 22, the lighting device 30 is turned or off as an ordinary lighting device. On the other hand, if the interval from the last state change is shorter than the discharge time of the power unit 21 and the preset time duration of the switch detection unit 22, the control module 20 enters an automatic lighting mode. During this mode, when the activation unit 24 detects that the ambient light is dimmed (i.e., during night time), the control unit 23 is notified to engage the control switch 25 so that the lighting device 30 is turned on. When the activation unit 24 detects that the ambient light is brightened up (i.e., during day time), the control unit 23 is notified to engage the control switch 25 so that the lighting device 30 is turned off. When the light switch 11 is engaged again, the control module 20 is restored to an ordinary lighting mode.

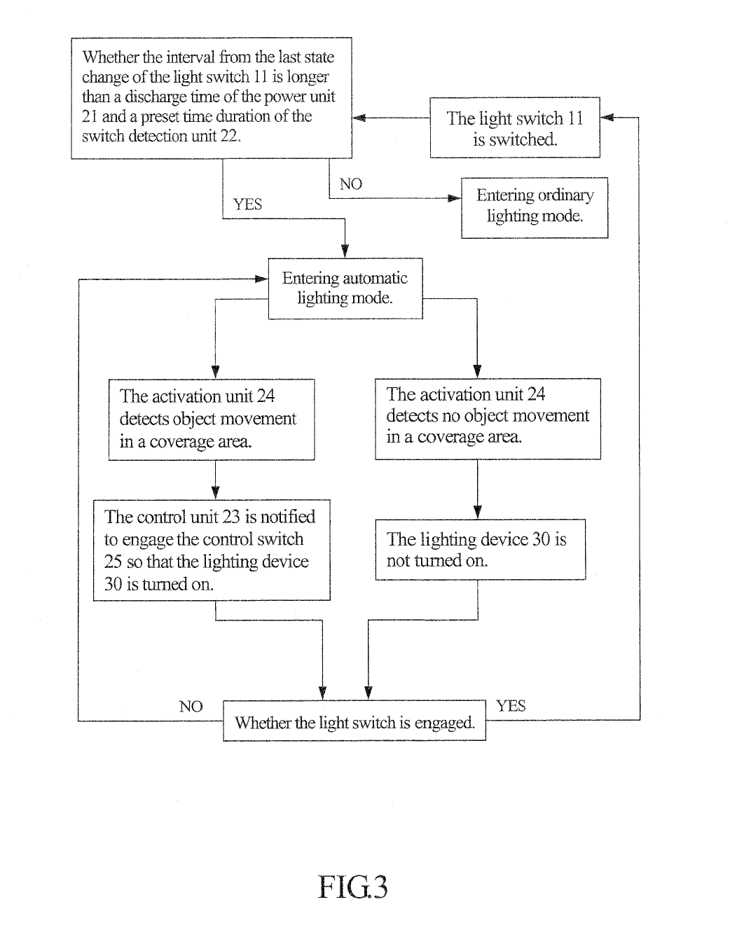

In a second embodiment illustrated in FIG. 3, when the light switch 11 is switched on or off and the interval from the last state change is longer than a discharge time of the power unit 21 and a preset time duration of the switch detection unit 22, the lighting device 30 is turned or off as an ordinary lighting device. On the other hand, if the interval from the last state change is shorter than the discharge time of the power unit 21 and the preset time duration of the switch detection unit 22, the control module 20 enters another automatic lighting mode. During this mode, when the activation unit 24 detects object movement in a coverage area, the control unit 23 is notified to engage the control switch 25 so that the lighting device 30 is turned on. When the activation unit 24 detects no disturbance, the control unit 23 is not notified and the lighting device 30 is not turned on. When the light switch 11 is engaged again, the control module 20 is restored to the ordinary lighting mode.

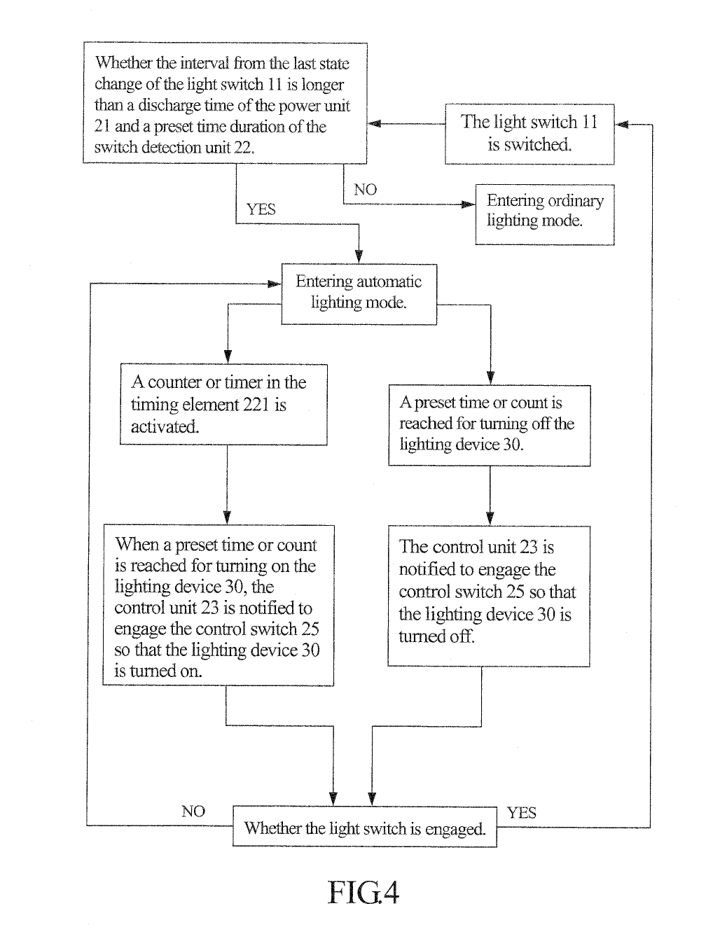

In a third embodiment illustrated in FIG. 4, when the light switch 11 is switched on or off and the interval from the last state change is longer than a discharge time of the power unit 21 and a preset time duration of the switch detection unit 22, the lighting device 30 is turned or off as an ordinary lighting device. On the other hand, if the interval from the last state change is shorter than the discharge time of the power unit 21 and the preset time duration of the switch detection unit 22, the control module 20 enters a third automatic lighting mode. During this mode, a counter or timer in the timing element 221 is activated and, when a preset time or count is reached, the control unit 23 is notified to engage the control switch 25 so that the lighting device 30 is turned on. Subsequently, when another time or count for turning off the light is reached, the control unit 23 is notified and the lighting device 30 is turned off.

Compared to the prior arts, the present invention has the following advantages.

First, a conventional automatic lighting device usually has a single trigger mechanism. The present invention allows the lighting device to be turned on and off by the brightness of ambient light, object movement, and preset schedules.

Secondly, a conventional automatic lighting device usually cannot function as an ordinary lighting device with simple on and off.

Thirdly, a light device of the present invention could directly replace a conventional one without altering any existing wiring and switch configuration.

The multiple trigger mechanisms offered by the present invention offer a more economic utilization of energy, as well as an enhanced operational life span for the lighting device.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. An automatic lighting system, comprising:
a lighting device;
a control module controlling said lighting device; and
a light switch through which said control module is connected to an in-house wiring in a series connection;
wherein said control module contains a power unit connecting said in-house wiring, a switch detection unit connecting said in-house wiring and said power unit, a control unit connecting said power unit and said switch detection unit, an activation unit connecting said power unit and said control unit, and a control switch connecting said in-house wiring and said control unit.

2. The automatic lighting system according to claim 1, wherein said switch detection unit contains a timing element capable of determining an interval time from the last state change of said light switch.

3. The automatic lighting system according to claim 1, wherein activation unit is one of a light-sensing activation unit, a motion-detection activation unit, and a time-based activation unit.

4. The automatic lighting system according to claim 1, wherein said light switch is a push button.
